(19) United States
(12) Patent Application Publication
(10) Pub. No.: US 2015/0301187 A1
(43) Pub. Date: Oct. 22, 2015

(54) METHOD AND APPARATUS FOR SELECTING SATELLITE SYSTEM

(71) Applicant: Samsung Electronics Co., Ltd., Suwon-si (KR)

(72) Inventors: Joonhwan LEE, Seoul (KR); Dohyoung CHUNG, Seoul (KR)

(21) Appl. No.: 14/691,883

(22) Filed: Apr. 21, 2015

(30) Foreign Application Priority Data
Apr. 22, 2014 (KR) 10-2014-0047837

(51) Int. Cl. G01S 19/28

(52) U.S. Cl. CPC G01S 19/28

(57) ABSTRACT

A method and an apparatus for selecting a satellite system which performs a positioning in an electronic device are provided. The method and apparatus include determining a Global Navigation Satellite System (GNSS) use mode, determining area information, the area information being information on an area where the electronic device is positioned, and selecting and activating at least one satellite system suitable for the area information among a plurality of GNSSs.

### CROSS-REFERENCE TO RELATED APPLICATION(S)

This application claims the benefit under 35 U.S.C. §119(a) of a Korean patent application filed on Apr. 22, 2014 in the Korean Intellectual Property Office and assigned Serial number 10-2014-0047837, the entire disclosure of which is hereby incorporated by reference.

### TECHNICAL FIELD

The present disclosure relates to a method and an apparatus for selecting a satellite system which performs a positioning in an electronic device.

### BACKGROUND

An electronic device may be convenient to provide position information to a user due. For example, the electronic device may detect a current position, and may provide search and navigation functions for a specific place (e.g., a hospital and a restaurant) which is nearest from the current position.

In order to provide a position based service as described above, a process of collecting position information by an electronic device is required. The electronic device may use a Global Navigation Satellite System (GNSS) in order to collect the position information. The GNSS may include a satellite system such as a Global Positioning System (GPS) (The United States), a GLONASS (Russia), a Galileo (Europe) and a BeiDou (China). When the electronic device performs a positioning using the GNSS, the electronic device may use each satellite system by individually selecting each satellite system or may combine other satellite systems based on the GPS to use the combined satellite system.

The above information is presented as background information only to assist with an understanding of the present disclosure. No determination has been made, and no assertion is made, as to whether any of the above might be applicable as prior art with regard to the present disclosure.

### SUMMARY

When a positioning is performed using a Global Navigation Satellite System (GNSS), various types of satellite systems may be used. Since use bands of each satellite system in the GNSS are different from each other, the more the types of the satellite systems to be searched is, the wider a used frequency band in the case of searching the satellite system should be. That is, when all types of satellite systems on earth are searched, current consumption may increase.

In addition, recently, in the case of a specific satellite system, since a difference of a visibility according to an area is high, there may be an unusable area. In an area where a visibility for such a specific satellite system is insufficient, decoding a signal of a corresponding satellite system and using the signal for positioning may cause a reduction in accuracy.

Aspects of the present disclosure are to address at least the above-mentioned problems and/or disadvantages and to provide at least the advantages described below. Accordingly, an aspect of the present disclosure is to provide a method and an apparatus for selecting a satellite system which performs a positioning in an electronic device.

In accordance with an aspect of the present disclosure, a method which prevents unnecessary current consumption owing to a search for all types of GNSS satellite systems on earth and selectively uses a satellite system in order to increase an accuracy of a positioning in a specific area is provided. The method includes selecting a satellite system optimized to a current position and performing a positioning through the selected satellite system. Therefore, an aspect of the present disclosure may provide a relatively accurate positioning method and reduce unnecessary current consumption generated when a positioning is performed.

In accordance with another aspect of the present disclosure, an electronic device is provided. The electronic device includes a control unit configured to determine a use mode of a Global Navigation Satellite System (GNSS), to determine area information, the area information being information on an area where the electronic device is positioned, and to select and activates at least one satellite system suitable for the area information among a plurality of GNSSs.

In accordance with another aspect of the present disclosure, a method of selecting a satellite system in an electronic device is provided. The method includes determining a use mode of a GNSS, determining area information, the area information being information on an area where the electronic device is positioned, and selecting and activating at least one satellite system suitable for the area information among a plurality of GNSSs.

In accordance with another aspect of the present disclosure, a computer-readable recording medium is provided. The computer-readable recording medium includes recording a program for executing determining a use mode of a GNSS, determining area information, the area information being information on an area where the electronic device is positioned, and selecting and activating at least one satellite system suitable for the area information among a plurality of GNSSs.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to various embodiments of the present disclosure;

FIG. 2 is a block diagram illustrating a construction of an electronic device according to various embodiments of the present disclosure;

FIG. 3 is a view illustrating a Global Navigation Satellite System (GNSS) list database (DB) according to an embodiment of the present disclosure;

FIG. 4 is a flowchart illustrating an operation of selecting a satellite system for positioning in the electronic device according to an embodiment of the present disclosure;

FIG. 5 is a view illustrating a GNSS selection menu according to an embodiment of the present disclosure;

FIG. 6 is a block diagram illustrating a construction of an electronic device according to various embodiments of the present disclosure; and

FIG. 7 illustrates communication protocols between a plurality of electronic devices according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which may be used in various embodiments of the present disclosure and does not limit one or more additional functions, operations, or components. Further, as used in an embodiment of the present disclosure, the terms “include”, “have” and their conjugates may be construed to denote a certain characteristic, number, operation, constituent element, component or a combination thereof, but may not be construed to exclude the existence of or a possibility of addition of one or more other characteristics, numbers, operations, constituent elements, components or combinations thereof

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of various embodiments but does not limit the corresponding components. For example, the above expressions do not limit the sequence and/or importance of the corresponding elements. The expressions may be used to distinguish a component element from another component element. For example, a first user device and a second user device indicate different user devices although both of them are user devices. For example, without departing from the scope of the present disclosure, a first component element may be named a second component element. Similarly, the second component element also may be named the first component element.

It should be noted that if it is described that one component element is “coupled” or “connected” to another component element, the first component element may be directly coupled or connected to the second component, and a third component element may be “coupled” or “connected” between the first and second component elements. Conversely, when one component element is “directly coupled” or “directly connected” to another component element, it may be construed that a third component element does not exist between the first component element and the second component element.

In the present disclosure, the terms are used to describe a specific embodiment, and are not intended to limit the present disclosure.

Unless defined differently, all terms used herein, which include technical terminologies or scientific terminologies, have the same meaning as a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Electronic devices according to various embodiments of the present disclosure may be devices adopting a communication function. For example, the electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a Moving Picture Experts Group (MPEG-1 or MPEG-2) Audio Layer III (MP3) player, a mobile medical device, a camera, a wearable device (e.g., a Head-Mounted-Device (HMD) such as electronic glasses, electronic clothes, an electronic bracelet, an electronic necklace, an electronic appcessory, an electronic tattoo, and a smart watch.

According to an embodiment of the present disclosure, an electronic device may be a smart home appliance with a communication function. The smart home appliance as an example of the electronic device may include at least one of, for example, a television, a Digital Video Disk (DVD) player, an audio system, a refrigerator, an air conditioner, a vacuum cleaner, an oven, a microwave oven, a washing machine, an air cleaner, a set-top box, a Television (TV) box (e.g., Samsung HomeSync™, Apple TV™, or Google TV™), a game console, an electronic dictionary, an electronic key, a camcorder, and an electronic picture frame.

According to various embodiments of the present disclosure, the electronic device may include at least one of various medical appliances (e.g., magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), an automotive infotainment device, electronic equipment for ships (e.g., ship navigation equipment and a gyrocompass), avionics, security equipment, a vehicle head unit, an industrial or home robot, an automatic teller machine (ATM) of a banking system, and a point of sales (POS) of a shop.

According to an embodiment of the present disclosure, the electronic devices may include at least one of furniture or a part of a building/structure having a communication function, electronic boards, electronic signature receiving devices, projectors, or various measuring equipment (e.g., equipment for a water supply, an electricity, gases or radio waves). An electronic device according to various embodiments of the present disclosure may be a combination of one or more of above described various devices. Also, an electronic device according to various embodiments of the present disclosure may be a flexible device. Also, an electronic device according to various embodiments of the present disclosure is not limited to the above described devices.

Hereinafter, an electronic device according to various embodiments of the present disclosure will be described with reference to the accompanying drawings. In various embodiments of the present disclosure, the term “user” may indicate a person using an electronic device or a device (e.g., an artificial intelligence electronic device) using an electronic device.

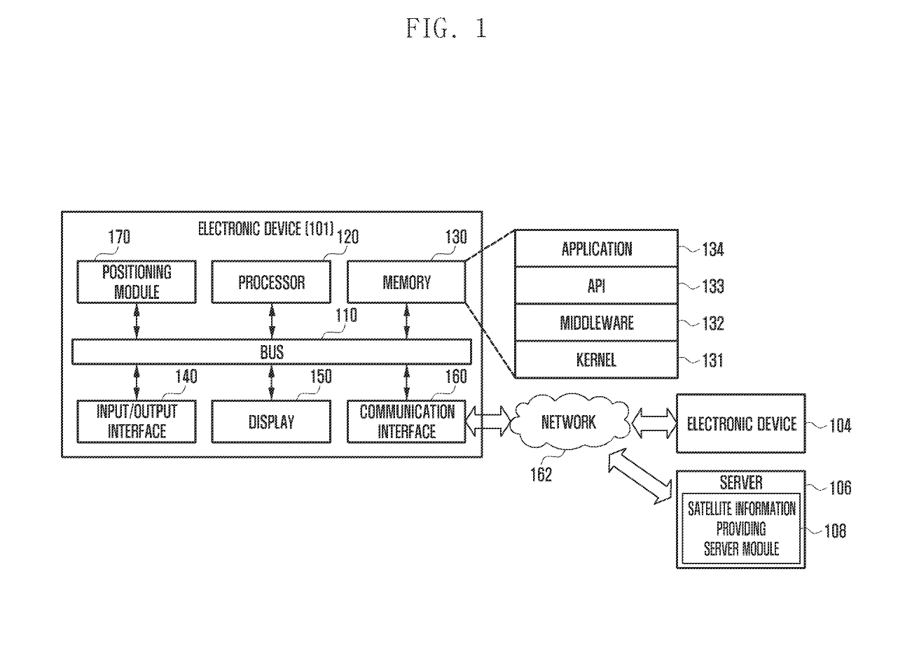

FIG. 1 is a diagram illustrating the network architecture including the electronic device according to various embodiments of the present disclosure.

Referring to FIG. 1, an electronic device 101 includes a bus 110, a processor 120, a memory 130, an input/output interface 140, a display 150, a communication interface 160, and a positioning module 170, but not limited thereto.

The bus 110 may be a circuitry, which connects the aforementioned components to each other to communicate signals (e.g., control messages) therebetween.

The processor 120 receives a command from any of the aforementioned components (e.g., the memory 130, the input/output interface 140, the display 150, the communication interface 160, and the positioning module 170) through the bus 110, interprets the command, and executes operation or data processing according to the decrypted command.

The memory 130 may store the command or data received from the processor 120 or other components (e.g., the input/output interface 140, the display 150, the communication interface 160, the positioning module 170, and the like) or generated by the processor 120 or other components. The memory 130 may store program modules including kernel 131, middleware 132, Application Programming Interface (API) 133, applications 134, and the like. Each programming module may be implemented as software, firmware, hardware, and any combination thereof

The kernel 131 may control or manage the system resources (e.g., the bus 110, the processor 120, and the memory 130) for use in executing the operation or function implemented with the middleware 132, the API 133, or the application 134. The kernel 131 also may provide an interface allowing the middleware 132, the API 133, or the application 134 to access the components of the electronic device 101 to control or manage.

The middleware 132 may work as a relay of data communicated between the API 133 or application 134 and the kernel 131. The middleware 132 may execute control of the task requests from the applications 134 in such a way of assigning priority for use of the system resource (e.g., the bus 110, the processor 120, and the memory 130) of the electronic device to at least one of the applications 134.

The API 133 is the interface for the applications 134 to control the function provided by the kernel 131 or the middleware 132 and may include at least one interface or function (e.g., a command) for file control, window control, image control, or text control.

According to various embodiments of the present disclosure, the applications 134 may include a Short Messaging Service (SMS)/Multimedia Messaging Service (MMS) application, an email application, a calendar application, an alarm application, a health care application (e.g., application of measuring quantity of motion or blood sugar level), and an environmental information application (e.g., atmospheric pressure, humidity, and temperature applications). Additionally or alternatively, the application 134 may be an application related to information exchange between the electronic device 101 and other external electronic device (e.g., another electronic device 104). Examples of the information exchange application may include a notification relay application for relaying specific information to the other electronic device 104 and a device management application for managing the external electronic device.

For example, the notification relay application may be provided with a function of relaying the alarm information generated by the other applications (e.g., SMS/MMS application, email application, health care application, and environmental information application) of the electronic device to an external electronic device (e.g., the other electronic device 104). Additionally or alternatively, the notification relay application may provide the user with the notification information received from an external electronic device (e.g., the other electronic device 104). The electronic device application may manage (e.g., install, delete, and update) the function of an external electronic device (e.g., turn-on/off of the other electronic device 104 itself (or a part of it) or adjustment of the brightness (or resolution) of the display) which communicates with the electronic device 101 or the service (e.g., communication or messaging service) provided by the external electronic device or an application running on the external device.

According to various embodiments of the present disclosure, the applications 134 may include an application designated according to the property (e.g., type) of an external electronic device (i.e., the other electronic device 104). If the external electronic device is the MP3 player, the applications 134 may include a music playback application. Similarly, if the external electronic device is a mobile medical appliance, the applications 134 may include a health care application. According to an embodiment of the present disclosure, the application 134 may include at least one of applications designated to the electronic device 101 or the applications received from the external electronic device (e.g., a server 106 and the other electronic device 104).

The input/output interface 140 delivers the command or data input by the user through with an input/output device (e.g., sensor, keyboard, and touchscreen) to the processor 120, memory 130, communication interface 160, and/or positioning module 170 through the bus 110. For example, the input/output interface 140 may provide the processor 120 with the data corresponding to the touch may by the user on the touchscreen. The input/output interface 140 may output the command or data (i.e., received from the processor 120, memory 130, communication interface 160, or the positioning module 170 through the bus 110) through the input/output device (e.g., a speaker and a display). For example, the input/out interface 140 may output the voice data processed by the processor 120 to the user through the speaker.

The display 150 may present various information (e.g., multimedia data and text data) to the user.

The communication interface 160 may establish a communication connection of the electronic device 101 with an external device (e.g., the other electronic device 104 and the server 106). For example, the communication interface 160 connects to a network 162 through a wireless or wired link for communication with the external device. Examples of the wireless communication technology may include wireless fidelity (Wi-Fi), Bluetooth (BT), Near Field Communication (NFC), GPS, and cellular communication technology (e.g., Long Term Evolution (LTE), LTE-Advanced (LTE-A), Code Division Multiple Access (CDMA), Wideband CDMA (WCDMA), Universal Mobile Telecommunication System (UMTS), Wireless-Broadband (WiBro), and General System for Mobile communications (GSM)). Examples of the wired communication technology may include Universal Serial Bus (USB), High Definition Multimedia Interface (HDMI), Recommended Standard 232 (RS-232), and Plain Old Telephone Service (POTS).

According to an embodiment of the present disclosure, the network 162 may be a telecommunication network. The communication network may include at least one of computer network, Internet, Internet of Things, and telephone network. According to an embodiment of the present disclosure, the communication protocol between the electronic device 101 and an external device (e.g., a transport layer protocol, a data link layer protocol, and a physical layer protocol) may be supported by at least one of the applications 134, API 133, middleware 132, kernel 131, and communication interface 160.

According to an embodiment of the present disclosure, the server 106 may support a driving of the electronic device 101 by performing at least one of operations (or functions) implemented in the electronic device 101. For example, the server 106 may include a satellite information providing server module 108 which may support a positioning module 170 implemented in the electronic device 101. For example, the satellite information providing server module 108 may include at least one element of the positioning module 170 and perform (e.g., replace) at least one operation among operations performed by the positioning module 170. For example, the satellite information providing server module 108 may store information pre-received from a satellite for a predetermined period and provide subsidiary information to a positioning module 170. For example, the subsidiary information may be provided to the positioning module 170 during a searching for a satellite system so as to reduce a time required in searching for a satellite system.

The positioning module 170 may perform an operation related to a positioning. For example, the positioning module 170 may communicate with the satellite system performing a positioning and generate position related information based on the information received from the satellite system. The satellite systems performing such a positioning may be referred to as a Global Navigation Satellite System (GNSS). The GNSS disclosed in the present specification refers to satellite systems providing position information of things on the ground using the satellite system. The GNSS may include a plurality of satellite systems such as a GPS of the United States, a Galileo of Europe, a GLONASS of Russia, and a BeiDou of China.

According to an embodiment of the present disclosure, at least one element of the positioning module 170 may be included in the server 106 (e.g., the satellite information providing server module 108), and may be supported at least one operation implemented in the positioning module 170 from the server 106.

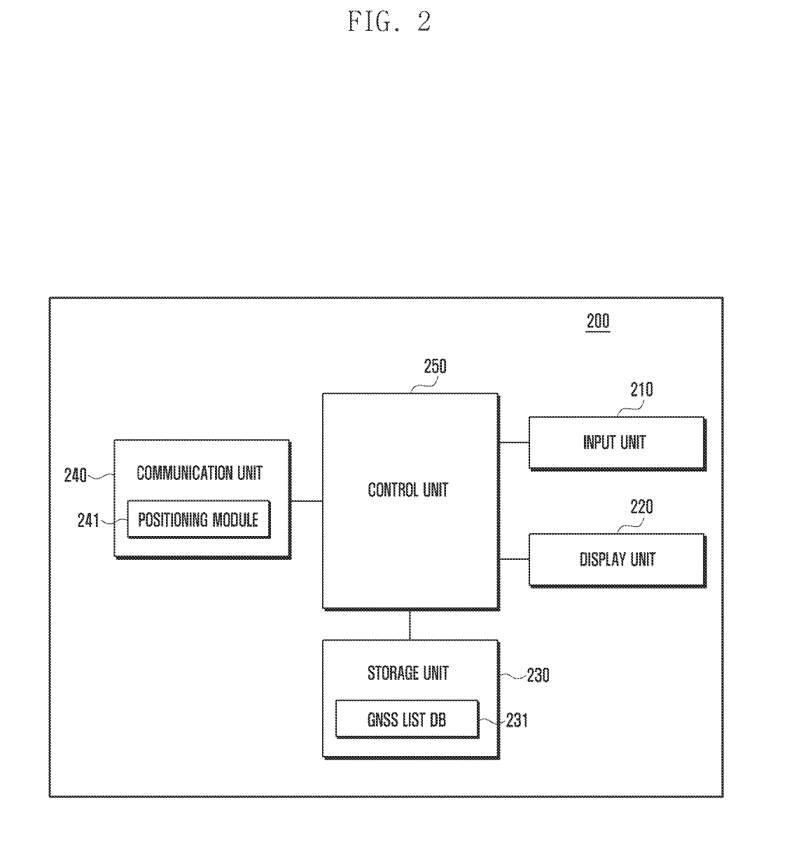

FIG. 2 is a block diagram illustrating a construction of an electronic device according to various embodiments of the present disclosure.

Referring to FIG. 2, an electronic device 200 according to various embodiments of the present disclosure may include an input unit 210, a display unit 220, a storage unit 230, a communication unit 240 and a control unit 250. In addition, the storage unit 230 may include a GNSS list Database (DB) 231, and the communication unit 240 may include a positioning module 241.

The input unit 210 may receive various user's inputs such as a key input and a touch input. Such an input unit 210 may correspond to a touch panel, an external key, and the like. Various sensors which determine a slope, a vibration, and the like may be included in the input unit 210. According to an embodiment of the present disclosure, the input unit 210 may receive a user's selection when an operation enabling a function of receiving a GNSS signal and at least one satellite system to be scanned among the GNSSs are selected.

The display unit 220 may display a screen under a control of the control unit 250. When a construction of the selected GNSS satellite system is changed, the display unit 220, according to an embodiment of the present disclosure, may display information notifying the change on a screen. In addition, when the electronic device is configured such that the GNSS satellite system is manually selected according to a user's selection, the display unit 220 may display a GNSS selection menu showing satellite systems which may be selected on the screen.

The storage unit 230 may store various programs and data necessary to drive the electronic device 200. The storage unit 230, according to an embodiment of the present disclosure, may store a program for changing information of the GNSS to be scanned. Alternatively, when the electronic device is configured such that the GNSS satellite system to be scanned is automatically selected, the storage unit 230 may store a used GNSS list DB 231. The GNSS list DB 231 may include a satellite system construction suitable for each area such that a proper GNSS satellite system may be selected based on an area information. Herein the area information is information of an area where the electronic device 200 is positioned.

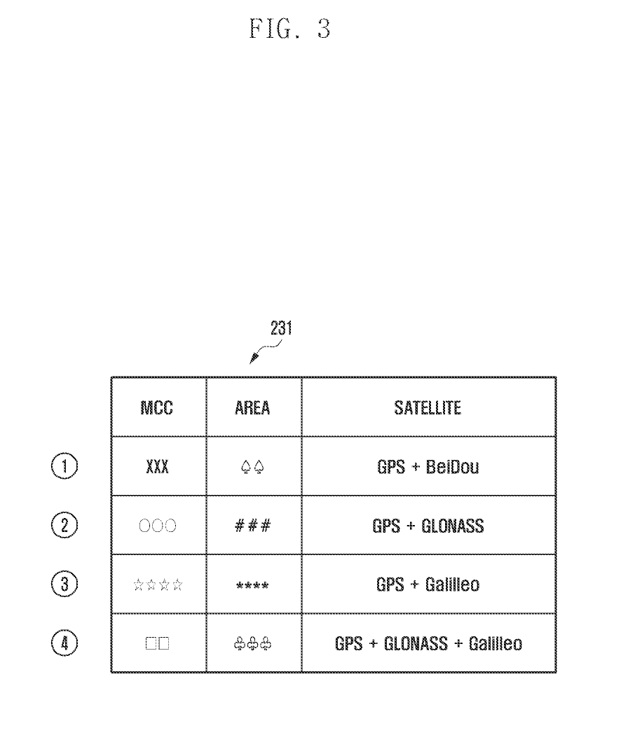

The GNSS list DB 231 will be described in more detail with reference to FIG. 3.

FIG. 3 is a view illustrating a construction of the GNSS list DB according to an embodiment of the present disclosure.

Referring to FIG. 3, in the GNSS list DB 231, a Mobile Country Code (MCC) (i.e., country information) or a Mobile Network Code (MNC) (i.e., service provider information), area information corresponding to the MCC or MNC, and a combination of the GNSS effective to a corresponding area may be recorded. The control unit 250 may select a satellite system which may perform a positioning effectively in a corresponding area according to the area information indicated by the MCC and MNC based on these recorded in the GNSS list DB 231. For example, if an MCC detected by the electronic device 200 is the same as a first row of FIG. 3, when a satellite system to be activated is automatically selected, ‘GPS+BeiDou’ may be configured as satellite systems to be activated according to information mapped to the first row. In a similar manner, when the control unit 250 determines that the area information of the electronic device 200 is the same area information recorded in a second row, the control unit 250 may activate ‘GPS+GLONASS.’ This operation may be equally applied to the remaining third and fourth rows.

The communication unit 240 may support various wired or wireless communications such as an Internet connection, a text message transmission and reception, or a short range wireless pairing in the electronic device 200. The communication unit 240, according to an embodiment of the present disclosure, may collect information of a country where the electronic device 200 is positioned through the MCC and MNC. An addition of the MCC and the MNC may be referred to a Public Land Mobile Network (PLMN) identifier (id), and this may be determined when a booting is finished if the electronic device 200 supports a cellular service. The MCC is a number given differently according to each country, and for example, Korea may be determined as ‘450’ and China may be determined as ‘460.’ In addition, the MNC is a number differently given according to each service provider. That is, the electronic device 200 may determine whether the MCC and the MNC determined through the communication unit 240 are changed. When the MCC and the MNC are changed, the electronic device 200 may determine that an area and a country are changed. According to various embodiments of the present disclosure, the communication unit 240 may use a means except for the MCC and the MNC as a means for detecting the position information. For example, the current position may be detected in a state unit and a town unit in addition to the country. The current position may be a specified area such as a continent (e.g., Europe and North America), or a cultural area (e.g., Islam and Hindu). Alternatively, the current position may be divided into an urban area and a suburban area. Furthermore, the current position may be divided into an inside of a building and an outside of the building.

In addition, the communication unit 240 may include a positioning module 241. The positioning module 241 may receive the collected position related signal from the GNSS using an activated GNSS. Furthermore, the positioning module 241 may write positioning related data (e.g., current position information, a path to a specific position, and the like) requested by a user, based on the received signal, and may display the positioning related data on a screen. In addition, according to an embodiment of the present disclosure, the positioning module 241 may select at least one satellite system among the various GNSSs, and receive a signal related to the position of the electronic device 200 through the selected satellite system.

The control unit 250 may control overall operations of the electronic device 200. The control unit 250, according to an embodiment of the present disclosure, may determine information indicated by at least one piece of information of the MCC and the MNC collected through the communication unit 240. In addition, the control unit 250 may determine changes of the MCC and the MNC, and thus the control unit 250 may determine an approximate position of an apparatus. The control unit 250 may detect the position of the apparatus, determine a type of the satellite system appropriate to be used in an area where the apparatus is currently positioned, and change a satellite system to be activated. At this time, when the control unit 250 selects a specific satellite system as an effective satellite system in a corresponding area, the control unit 250 may be operated according to the information of the GNSS list DB 231 pre-stored in the storage unit 230. In addition, information related to satellite systems according to each specific area may be added in the GNSS list DB 231 based on a use history, in addition to the pre-stored information.

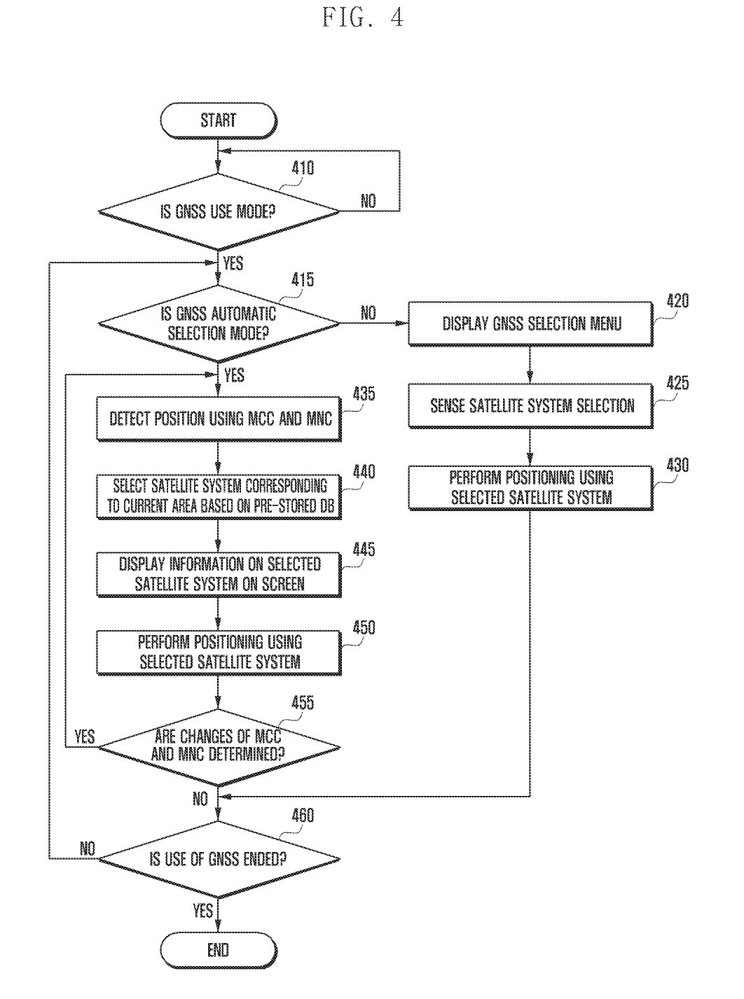

FIG. 4 is a flowchart illustrating an operation of selecting a satellite system for positioning in an electronic device according to various embodiments of the present disclosure.

Referring to FIG. 4, in operation 410, the control unit 250 may determine whether a GNSS use mode is selected in the electronic device 200. The GNSS use mode is a state in which a reception of a signal through the GNSS is allowed. In addition, as described above, the GNSS is a concept which refers to the satellite system such as the GPS, GLONASS, Galileo and BeiDou. A function of the GNSS use mode may be activated or released according to a configuration of a user. Therefore, in operation 410, the control unit 250 may perform an operation of determining whether the GNSS use mode is selected. In operation 415, the control unit 250 may determine whether it is a GNSS automatic selection mode. In the electronic device 200, when the GNSS signal may be used, a function of automatically or manually selecting the GNSS satellite system to be activated may be provided. When the control unit 250 determines that it is not the GNSS automatic selection mode in operation 415, the control unit 250 may perform operation 420. In operation 420, the control unit 250 may display a GNSS selection menu such that the satellite system may be selected according to a user's input. Thus, in operation 420, the user may determine selectable GNSS satellite systems.

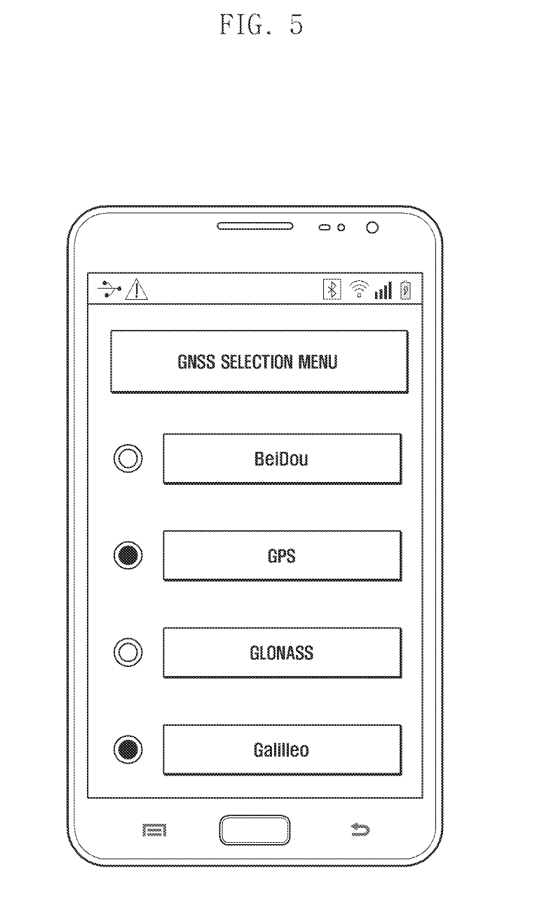

FIG. 5 is a view illustrating a GNSS selection menu on the screen by a control unit according to an embodiment of the present description.

Referring to FIG. 5, a display of the GNSS selection menu on the screen of the electronic device 200 is illustrated. Each satellite system corresponding to the GNSS is displayed on the screen such that the user may directly select the satellite system to be activated.

a type of the GNSS displayed in the GNSS selection menu may include the satellite systems such as the BeiDou GPS, GLONASS, and Galileo. Such a GNSS selection menu may be displayed in a case in which the user attempts to perform a positioning using a satellite system directly selected by the user in a specific area. In addition, the user may directly select a satellite system to be activated as a means for performing the positioning in the GNSS selection menu shown in FIG. 5. The screen of the GNSS selection menu may be constructed such that at least one satellite system may be activated according to the user's selection.

In operation 425 after operation 420, the control unit 250 may determine a satellite system selected according to a key input or a touch input of the user. In addition, the control unit 250 may detect a type of the selected satellite system and perform an arrangement for scanning a corresponding satellite system. For example, operations such as a configuration of a frequency band for scanning the corresponding satellite system may correspond to this. When the at least one satellite system is selected through the above-mentioned process such that at least one satellite system is activated, in operation 430, the control unit 250 may perform the positioning using the selected satellite system.

In contrast, when the control unit 250 determines that the control unit 250 is in the GNSS automatic selection mode in operation 415, in operation 435, the control unit 250 may perform an operation of detecting the position using at least one of the MCC and the MNC. The MCC refers to country information (i.e., information of a country where the electronic device 200 is positioned), and the MNC refers to a communication service provider information. The control unit 250 may detect the area information of the electronic device 200 by detecting at least one of the MCC and the MNC. The MCC and the MNC are information automatically collected when a power of the electronic device 200 is on state. The control unit 250 may interpret the area information indicated by the collected MCC and the MNC.

Next, in operation 440, the control unit 250 may select a satellite system suitable for a corresponding area among the GNSSs using the area information detected by the MCC and the MNC. At this time, in operation 440, the control unit 250 may select a construction of the satellite system corresponding to a current area based on a pre-stored DB. For example, at this time, the DB may be equal to the GNSS list DB 231 shown in FIG. 5.

The GNSS list DB 231 may be a database including the MCC (or other information corresponding to the MCC), area information referred by the MCC, an effective GNSS satellite system in an area of the area information, and the like. Alternatively, the GNSS list DB 231 may be formed based on a use history of the GNSS previously performed. When the control unit 250 selects the satellite system corresponding to the current area among the GNSSs, based on the pre-stored DB in operation 440, in operation 445, the control unit 250 may display information on the selected satellite system to the user. Next, in operation 450 after operation 445, the control unit 250 may perform the positioning using the selected satellite system. Furthermore, the control unit 250 may generate the position related data (e.g., a path finding) based on a signal received through the satellite system.

In operation 455, the control unit 250 may perform an operation of sensing the changes of the MCC and the MNC. For example, the changes of the MCC and the MNC may be determined when the electronic device 200 is moved in a relatively far distance (e.g., a country movement), after at least one of the MCC and the MNC is firstly determined. When the changes of the MCC and the MNC are determined, the control unit 250 may perform the operations below operation 435 again. In contrast, when the changes of the MCC and the MNC are not determined, in operation 460, the control unit 250 may determine whether a use of the GNSS is ended. When the control unit 250 determines that the use of the GNSS is ended, the operations of FIG. 4 may be ended. In contrast, the control unit 250 determines that the use of the GNSS is continuously allowed, the control unit 250 may perform the operations below operation 415 again.

A method of selecting a satellite system in the electronic device 200, according to various embodiments of the present disclosure, may include determining a use mode of a GNSS, determining area information, the area information being information on an area where the electronic device 200 is positioned, and selecting and activating at least one satellite system suitable for the area information among the GNSSs.

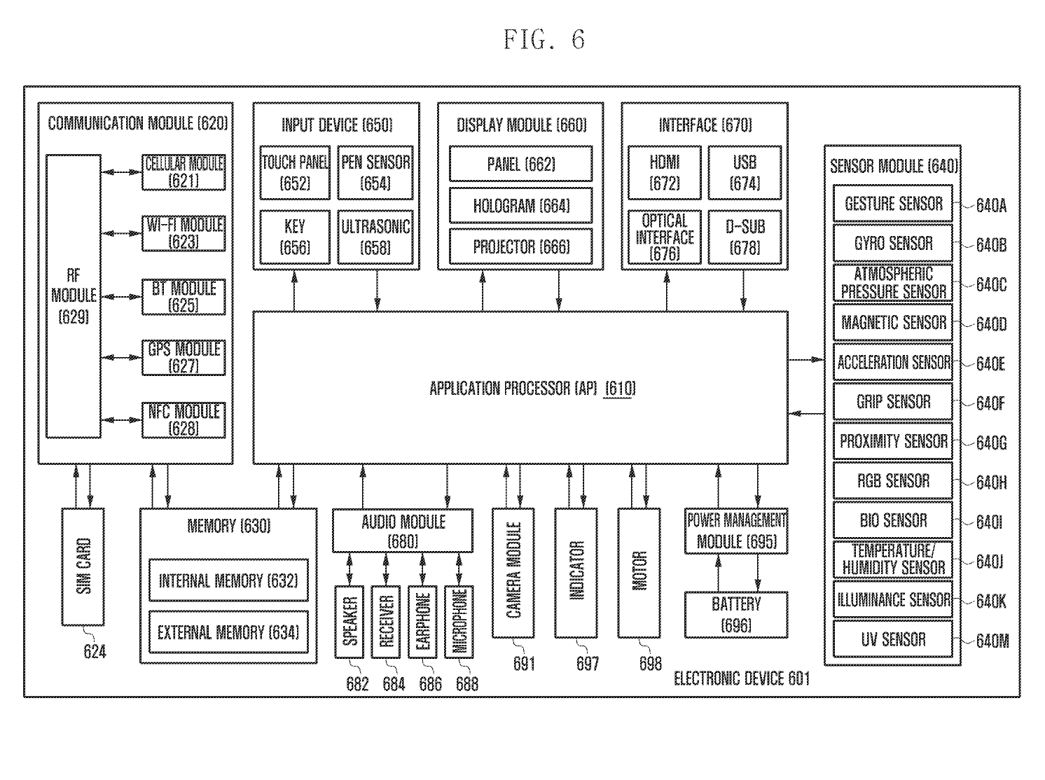

FIG. 6 illustrates a block diagram of an electronic device according to various embodiments of the present disclosure. The electronic device may include, for example, all or some of the electronic device 101 illustrated in FIG. 1.

Referring to FIG. 6, an electronic device 601 may include at least one Application Processor (AP) 610, a communication module 620, a Subscriber Identifier Module (SIM) card 624, a memory 630, a sensor module 640, an input device 650, a display 660, an interface 670, an audio module 680, a camera module 691, a power management module 695, a battery 696, an indicator 697, and a motor 698.

The AP 610 may control a plurality of hardware or software components connected to the AP 610 by driving an operating system or an application program and process various data including multimedia data and perform calculations. The AP 610 may be implemented by, for example, a System on Chip (SoC). According to an embodiment, the AP 610 may further include a Graphic Processing Unit (GPU).

The communication module 620 (e.g., the communication interface 160) may perform data transmission/reception in a communication between the electronic device 601 (e.g., the electronic device 101) and other electronic devices (e.g., the other electronic device 104 and the server 106) connected thereto through a network. According to an embodiment, the communication module 620 may include a cellular module 621, a Wi-Fi module 623, a BT module 625, a GPS module 627, an NFC module 628, and a Radio Frequency (RF) module 629.

The cellular module 621 may provide a voice call, a video call, an SMS, or an Internet service through a communication network (e.g., LTE, LTE-A, CDMA, WCDMA, UMTS, WiBro, or GSM). Furthermore, the cellular module 621 may distinguish and authenticate electronic devices within a communication network using, for example, a SIM (e.g., the SIM card 624). According to an embodiment of the present disclosure, the cellular module 621 may perform at least a part of functions that may be provided by the AP 610. For example, the cellular module 621 may perform at least some of the multimedia control functions.

According to an embodiment of the present disclosure, the cellular module 621 may include a Communication Processor (CP). Furthermore, the cellular module 621 may be implemented by, for example, an SoC. Although the elements such as the cellular module 621 (e.g., a communication processor), the memory 630, and the power management module 695 are illustrated to be separate from the AP 610 in FIG. 6, the AP 610 may include at least some of the aforementioned elements (e.g., the cellular module 621) according to an embodiment of the present disclosure.

According to an embodiment of the present disclosure, the AP 610 or the cellular module 621 (e.g., a communication processor) may load a command or data received from at least one of a non-volatile memory and other elements connected thereto in a volatile memory, and may process the loaded command or data. Furthermore, the AP 610 or the cellular module 621 may store data received from or generated by at least one of other elements in a non-volatile memory.

The Wi-Fi module 623, the BT module 625, the GPS module 627, and the NFC module 628 may include, for example, a processor for processing data transmitted/received through the corresponding module. Although the cellular module 621, the Wi-Fi module 623, the BT module 625, the GPS module 627, and the NFC module 628 are illustrated as separate blocks in FIG. 6, at least some (e.g., two or more) of the cellular module 621, the Wi-Fi module 623, the BT module 625, the GPS module 627, and the NFC module 628 may be included in one Integrated Chip (IC) or one IC package according to an embodiment of the present disclosure. For example, at least some (e.g., the communication processor corresponding to the cellular module 621 and the Wi-Fi processor corresponding to the Wi-Fi module 623) of the processors corresponding to the cellular module 625, the Wi-Fi module 627, the BT module 628, the GPS module 621, and the NFC module 623 may be implemented by one SoC.

The RF module 629 may transmit/receive data, for example, an RF signal. Although not illustrated, the RF module 629 may include, for example, a transceiver, a Power Amplifier Module (PAM), a frequency filter, a Low Noise Amplifier (LNA), and the like. Further, the RF module 629 may further include a component for transmitting and receiving electromagnetic waves in a free space in a wireless communication, for example, a conductor, a conductive wire, or the like. Although the cellular module 621, the Wi-Fi module 623, the BT module 625, the GPS module 627, and the NFC module 628 share one RF module 629 in FIG. 6, at least one of the cellular module 621, the Wi-Fi module 623, the BT module 625, the GPS module 627, and the NFC module 628 may transmit/receive an RF signal through a separate RF module according to an embodiment of the present disclosure.

The SIM card 624 may be a card including a SIM, and may be inserted into a slot formed in a particular portion of the electronic device 601 (not shown). The SIM card 624 may include unique identification information (e.g., an Integrated Circuit Card IDentifier (ICCID)) or subscriber information (e.g., an International Mobile Subscriber Identity (IMSI)).

The memory 630 (e.g., the memory 130) may include an internal memory 632 or an external memory 634. The internal memory 632 may include, for example, at least one of a volatile memory (e.g., a Dynamic RAM (DRAM), a Static RAM (SRAM), a Synchronous DRAM (SDRAM), and the like), and a non-volatile Memory (e.g., a One Time Programmable ROM (OTPROM), a PROM, an Erasable and Programmable ROM (EPROM), an Electrically Erasable and Programmable ROM (EEPROM), a mask ROM, a flash ROM, a Not And (NAND) flash memory, a Not Or (NOR) flash memory, and the like).

According to an embodiment of the present disclosure, the internal memory 632 may be a Solid State Drive (SSD). The external memory 634 may further include a flash drive, for example, a Compact Flash (CF), a Secure Digital (SD), a (Micro-SD, a Mini-SD, an extreme Digital (xD), a memory stick, or the like. The external memory 634 may be functionally connected with the electronic device 601 through various interfaces. According to an embodiment of the present disclosure, the electronic device 601 may further include a storage device (or storage medium) such as a hard drive.

The sensor module 640 may measure a physical quantity or detect an operation state of the electronic device 601, and may convert the measured or detected information to an electronic signal. The sensor module 640 may include at least one of, for example, a gesture sensor 640A, a gyro sensor 640B, an atmospheric pressure sensor 640C, a magnetic sensor 640D, an acceleration sensor 640E, a grip sensor 640F, a proximity sensor 640G, a color sensor 640H (e.g., red, green, and blue (RGB) sensor), a bio-sensor 640I, a temperature/humidity sensor 640J, an illumination sensor 640K, and a Ultra Violet (UV) sensor 640M. Additionally or alternatively, the sensor module 640 may include, for example, an E-nose sensor (not illustrated), an electromyography (EMG) sensor (not illustrated), an electroencephalogram (EEG) sensor (not illustrated), an electrocardiogram (ECG) sensor (not illustrated), an Infrared (IR) sensor, an iris sensor (not illustrated), a fingerprint sensor, and the like. The sensor module 640 may further include a control circuit for controlling one or more sensors included therein.

The input device 650 may include a touch panel 652, a (digital) pen sensor 654, a key 656, or an ultrasonic input device 658. The touch panel 652 may recognize a touch input through at least one of a capacitive type, a resistive type, an infrared type, and an ultrasonic wave type. The touch panel 652 may further include a control circuit. The capacitive type touch panel may recognize a physical contact or a proximity. The touch panel 652 may further include a tactile layer. In this case, the touch panel 652 may provide a tactile reaction to the user.

The (digital) pen sensor 654 may be implemented, for example, using a method identical or similar to a method of receiving a touch input of the user, or using a separate recognition sheet. The key 656 may include, for example, a physical button, an optical key, or a keypad. The ultrasonic input device 658 may identify data by detecting an acoustic wave with a microphone (e.g., a microphone 688) of the electronic device 601 through an input unit generating an ultrasonic signal, and may perform a wireless recognition. According to an embodiment of the present disclosure, the electronic device 601 may receive a user input from an external device (e.g., a computer or a server) connected thereto using the communication module 620.

The display 660 (e.g., the display 150) may include a panel 662, a hologram device 664, or a projector 666. The panel 662 may be, for example, a Liquid Crystal Display (LCD) or an Active Matrix Organic Light Emitting Diode (AM-OLED). The panel 662 may be implemented to be, for example, flexible, transparent, or wearable. The panel 662 may be configured by the touch panel 652 and one module. The hologram 664 may show a stereoscopic image in the air using an interference of light. The projector 666 may project light onto a screen to display an image. The screen may be located, for example, inside or outside the electronic device 601. According to an embodiment of the present disclosure, the display 660 may further include a control circuit for controlling the panel 662, the hologram device 664, or the projector 666.

The interface 670 may include, for example, an HDMI 672, a USB 674, an optical interface 676, or a D-subminiature (D-sub) 678. The interface 670 may be included in, for example, the communication interface 160 illustrated in FIG. 1. Additionally or alternatively, the interface 670 may include, for example, a Mobile High-definition Link (MHL) interface, an SD card/Multi-Media Card (MMC) interface, or an Infrared Data Association (IrDA) standard interface.

The audio module 680 may bilaterally convert a sound and an electronic signal. At least some elements of the audio module 680 may be included in, for example, the input/output interface 140 illustrated in FIG. 1. The audio module 680 may process sound information input or output through, for example, the speaker 682, the receiver 684, the earphones 686, the microphone 688 or the like.

The camera module 691 is a device for capturing a still image or a video, and according to an embodiment of the present disclosure, may include one or more image sensors (e.g., a front sensor or a rear sensor), a lens (not illustrated), an Image Signal Processor (ISP) (not illustrated), or a flash (not illustrated) (e.g., an LED or a xenon lamp).

The power managing module 695 may manage power of the electronic device 601. Although not illustrated, the power management module 695 may include, for example, a Power Management IC (PMIC), a charger IC, or a battery or fuel gauge.

The PMIC may be mounted to, for example, an integrated circuit or an SoC semiconductor. Charging methods may be classified into a wired charging method and a wireless charging method. The charger IC may charge a battery and prevent an over voltage or an over current from being flowed from a charger. According to an embodiment of the present disclosure, the charger IC may include a charger IC for at least one of the wired charging method and the wireless charging method. A magnetic resonance scheme, a magnetic induction scheme, or an electromagnetic scheme may be exemplified as the wireless charging method, and an additional circuit for a wireless charging, such as a coil loop circuit, a resonance circuit, a rectifier circuit, and the like may be added.

The battery gauge may measure, for example, a remaining quantity of the battery 696, or a voltage, a current, or a temperature during the charging. The battery 696 may store or generate electricity, and may supply power to the electronic device 601 using the stored or generated electricity. The battery 696 may include, for example, a rechargeable battery or a solar battery.

The indicator 697 may display a specific status of the electronic device 601 or a part (e.g., the AP 610) of electronic device, for example, a booting status, a message status, a charging status, and the like. The motor 698 may convert an electrical signal to a mechanical vibration. Although not illustrated, the electronic device 601 may include a processing unit (e.g., a GPU) for supporting a mobile TV. The processing device for supporting the mobile TV may process, for example, media data according to a standard of Digital Multimedia Broadcasting (DMB), Digital Video Broadcasting (DVB), media flow or the like.

Each of the described component elements of the hardware according to the present disclosure may be formed of one or more components, and a name of a corresponding component element may be changed based on a type of an electronic device. The electronic device according to the present disclosure may include one or more of the aforementioned components or may further include other additional components, or some of the aforementioned components may be omitted. Further, some of the components of the electronic device according to the various embodiments of the present disclosure may be combined to form a single entity, and thus, may equivalently execute functions of the corresponding elements prior to the combination.

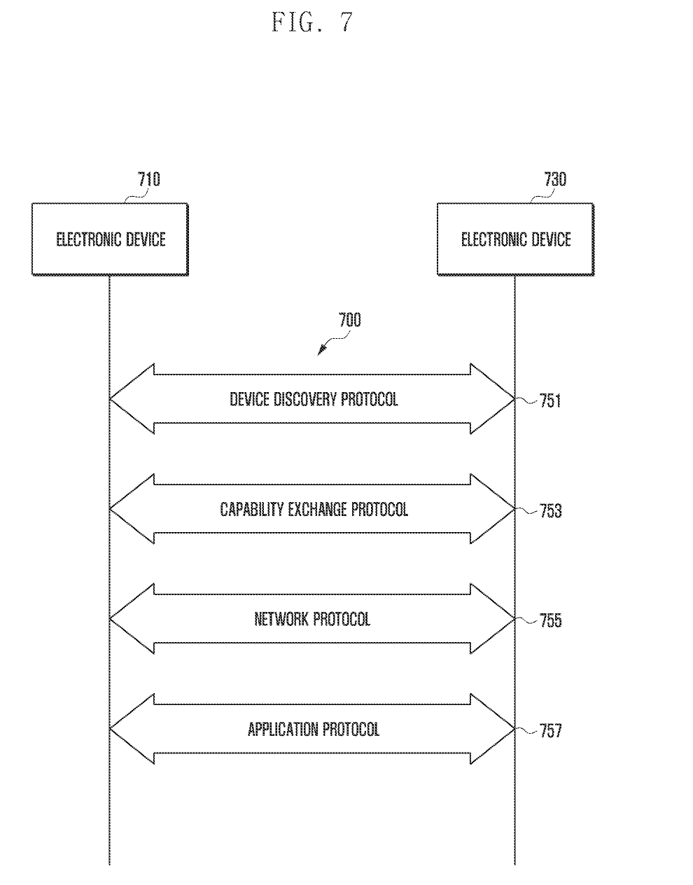

FIG. 7 illustrates communication protocols between a plurality of electronic devices according to various embodiments of the present disclosure.

Referring to FIG. 7, communication protocols 700 are instituted between a plurality of electronic devices 710 and 730 and may include a device discovery protocol 751, a capability exchange protocol 753, a network protocol 755, and an application protocol 757. According to an embodiment of the present disclosure, the device discovery protocol 751 may be a protocol by which the electronic devices (e.g., the electronic device 710 and the electronic device 730) detect external devices capable of communicating with the electronic devices, or connect with the detected external electronic devices. For example, the electronic device 710 (e.g., the electronic device 101) may detect the electronic device 730 (e.g., the other electronic device 104) as an electronic device capable of communicating with the electronic device 710 through communication methods (e.g., Wi-Fi, BT, USB, or the like) which are available in the electronic device 710, by using the device discovery protocol 751. In order to connect with the electronic device 730 for communication, the electronic device 710 may obtain and store identification information on the detected electronic device 730, by using the device discovery protocol 751. The electronic device 710 may initiate the communication connection with the electronic device 730, for example, based on at least the identification information.

According to an embodiment of the present disclosure, the device discovery protocol 751 may be a protocol for authentication between a plurality of electronic devices. For example, the electronic device 710 may perform authentication between the electronic device 710 and the electronic device 730, based on at least communication information (e.g., Media Access Control (MAC), Universally Unique Identifier (UUID), Subsystem Identification (SSID), Internet Protocol (IP) address) for connection with the electronic device 730.

According to an embodiment of the present disclosure, the capability exchange protocol 753 may be a protocol for exchanging information related to service functions which may be supported by at least one of the electronic device 710 or the electronic device 730. For example, the electronic device 710 and the electronic device 730 may exchange information on service functions, which are currently supported by each electronic device with each other through the capability exchange protocol 753. The exchangeable information may include identification information indicating a specific service among a plurality of services supported by the electronic device 710 and the electronic device 730. For example, the electronic device 710 may receive identification information for a specific service provided by the electronic device 730 from the electronic device 730 through the capability exchange protocol 753. In this case, the first electronic device 710 may determine whether the electronic device 710 may support the specific service, based on the received identification information.

According to an embodiment of the present disclosure, the network protocol 755 may be a protocol for controlling the data flow which is transmitted and received between the electronic devices (e.g., the electronic device 710 and the electronic device 730) connected with each other for communication, for example, in order to provide interworking services. For example, at least one of the electronic device 710 or the electronic device 730 may perform the error control or the data quality control, by using the network protocol 755. Alternatively or additionally, the network protocol 755 may determine the transmission format of data transmitted and received between the electronic device 710 and the electronic device 730. In addition, at least one of the electronic device 710 or the electronic device 730 may manage a session (e.g., session connection or session termination) for the data exchange between them, by using the network protocol 755.

According to an embodiment of the present disclosure, the application protocol 757 may be a protocol for providing a procedure or information to exchange data related to services which are provided to the external devices. For example, the electronic device 710 (e.g., the electronic device 101) may provide services to the electronic device 730 (e.g., the other electronic device 104 or the server 106) through the application protocol 757.

According to an embodiment of the present disclosure, the communication protocol 700 may include standard communication protocols, communication protocols designated by individuals or groups (e.g., communication protocols designated by communication device manufacturers or network providers), or a combination thereof

The term “module” used in the present disclosure may refer to, for example, a unit including at least one combination of hardware, software, and firmware. The “module” may be interchangeably used with a term, such as unit, logic, logical block, component, and/or circuit. The “module” may be a minimum unit of an integrally configured article and/or a part thereof The “module” may be a minimum unit performing at least one function and/or a part thereof The “module” may be mechanically and/or electronically implemented. For example, the “module” according to the present disclosure may include at least one of an Application-Specific IC (ASIC) chip, a Field-Programmable Gate Array (FPGA), and a programmable-logic device for performing operations which has been known and/or are to be developed hereinafter.

According to various embodiments of the present disclosure, at least some of the devices (e.g., modules or functions thereof) or the method (e.g., operations) according to the present disclosure may be implemented by a command stored in a computer-readable storage medium in a programming module form. When the instructions are executed by at least one processor, the at least one processor may perform functions corresponding to the instructions. The computer-readable storage medium may be, for example, the memory. At least a part of the programming module may be implemented (e.g., executed) by, for example, the processor. At least some of the programming modules may include, for example, a module, a program, a routine, a set of instructions or a process for performing one or more functions.

The computer-readable recording medium may include magnetic media such as a hard disk, a floppy disk, and a magnetic tape, optical media such as a Compact Disc ROM (CD-ROM) and a DVD, magneto-optical media such as a floptical disk, and hardware devices specially configured to store and perform a program instruction (e.g., programming module), such as a ROM, a RAM, a flash memory and the like. In addition, the program instructions may include high class language codes, which may be executed in a computer by using an interpreter, as well as machine codes made by a compiler. The aforementioned hardware device may be configured to operate as one or more software modules in order to perform the operation of the present disclosure, and vice versa.

A module or a programming module according to the present disclosure may include at least one of the described component elements, a few of the component elements may be omitted, or additional component elements may be included. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

An electronic device according to various embodiments of the present disclosure may include a control unit that controls to determine a use mode of GNSS, determine area information, the area information being information on an area where the electronic device is positioned, and select and activate at least one satellite system suitable for the area information among the GNSSs.

According to various embodiments of the present disclosure, in a recording medium storing instructions which are configured to enable at least one processor to perform at least one operation when the instructions are executed by at least one processor, at least one operation may include determining a use mode of a GNSS, determining area information, the area information being information on an area where the electronic device is positioned, and selecting and activating at least one satellite system suitable for the area information among the GNSSs.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of selecting a satellite system in an electronic device, the method comprising:
determining a use mode of a Global Navigation Satellite System (GNSS);
determining area information, the area information being information on an area where the electronic device is positioned; and
selecting and activating at least one satellite system suitable for the area information among a plurality of GNSSs.

2. The method of claim 1, wherein the determining of the area information comprises determining the area information by at least one of a Mobile country Code (MCC) and a Mobile Network Code (MNC) determined in the electronic device.

3. The method of claim 1,
wherein the selecting and activating of the at least one satellite system comprises automatically selecting a satellite system corresponding to the area information based on a pre-stored GNSS list database, and
wherein the pre-stored GNSS list database is recorded by including corresponding area information detected based on at least one of an MCC and an MNC, and construction information of a satellite system corresponding to each area.

4. The method of claim 3, wherein the selecting and activating of the at least one satellite system comprises displaying information on the satellite system according to a selection and an activation of the at least one satellite system among the the plurality of GNSSs.

5. The method of claim 1, further comprising:
manually selecting and activating the at least one satellite system.

6. The method of claim 5, wherein the manually selecting and activating of the at least one satellite system comprises:
displaying a GNSS selection menu listing a type of a satellite system which for selection;
determining a selection of at least one satellite system in the GNSS selection menu; and
activating the at least one selected satellite system.

7. The method of claim 1, further comprising:
performing a positioning using an activated satellite system when the at least one satellite system is activated.

8. The method of claim 1, wherein the GNSS includes a Global Positioning System (GPS), a GLONASS, a Galileo, or a BeiDou.

9. An electronic device selecting a satellite system, the electronic device comprising:
a control unit configured:
to determine a use mode of Global Navigation Satellite System (GNSS),
to determine area information, the area information being information on an area where the electronic device is positioned, and
to select and activate at least one satellite system suitable for the area information among a plurality of GNSSs.

10. The electronic device of claim 9, further comprising:
a communication unit configured to receive at last one of a Mobile country Code (MCC) and a Mobile Network Code (MNC) determined in the electronic device,
wherein the control unit is further configured to determine the area information by at least one of the MCC and the MNC.

11. The electronic device of claim 9, further comprising:
a storage unit configured to store a GNSS list database,
wherein the control unit is further configured to automatically select a satellite system corresponding to the area information based on the GNSS list database.

12. The electronic device of claim 11, wherein the GNSS list database is recorded by including corresponding area information detected based on at least one of an MCC and an MNC, and construction information of a satellite system corresponding to each area.

13. The electronic device of claim 9, wherein the control unit is further configured to display information on the satellite system according to a selection and an activation of the at least one satellite system among the plurality of GNSSs.

14. The electronic device of claim 9, wherein the control unit is further configured manually select and activate the at least one satellite system.

15. The electronic device of claim 14, wherein the control unit is further configured:
to manually select the at least one satellite system,
to display a GNSS selection menu listing a type of a satellite system for selection,
to determine a selection of at least one satellite system in the GNSS selection menu, and
to activate the at least one selected satellite system.

16. The electronic device of claim 10, wherein the communication unit further includes a positioning module which performs a positioning using the activated satellite system.

17. The electronic device of claim 9, wherein the GNSS includes a Global Positioning System (GPS), a GLONASS, a Galileo or a BeiDou.

18. A computer-readable recording medium which records thereon a computer program for executing instructions of a method of selecting a satellite system in an electronic device, the method comprising:
determining a use mode of a Global Navigation Satellite System (GNSS);
determining area information, the area information being information on an area where the electronic device is positioned; and
selecting and activating at least one satellite system suitable for the area information among a plurality of GNSSs.

19. The computer-readable recording medium of claim 18, wherein, when the position of the electronic device is outside of an area associated with each of the plurality of GNSSs, the selecting and activating of the at least one satellite system suitable for the area information among a plurality of GNSSs further comprises:
displaying a GNSS selection menu listing a type of a satellite system for selection;
determining a selection of at least one satellite system in the GNSS selection menu; and
activating the at least one selected satellite system.
